(19) United States
(12) Patent Application Publication
(10) Pub. No.: US 2008/0298229 A1
(43) Pub. Date: Dec. 4, 2008

(54) NETWORK WIDE TIME BASED CORRELATION OF INTERNET PROTOCOL (IP) SERVICE LEVEL AGREEMENT (SLA) FAULTS

(75) Inventors: Andrew Ballantyne, San Francisco, CA (US); Gil Sheinfeld, Sunnyvale, CA (US); Weigang Huang, Fremont, CA (US)

Correspondence Address: JACKSON & CO., LLP, 6114 LA SALLE AVENUE, #507, OAKLAND, CA, 94611-2802, US

(73) Assignee: Cisco Technology, Inc., San Jose, CA (US)

(21) Appl. No.: 11/757,305

(22) Filed: Jun. 1, 2007

(51) Int. Cl. G06F 11/00

(52) U.S. Cl. 370/218

(57) ABSTRACT

In particular embodiments, receiving a first connectivity fault notification, establishing a predetermined time period when the first connectivity fault notification is received, receiving one or more additional connectivity fault notifications during the predetermined time period, performing a root cause analysis for the connectivity fault notification based on the received first connectivity fault notification, and resolving the first and the one or more additional connectivity fault notifications based on the root cause analysis are provided.

### TECHNICAL FIELD

The present disclosure relates generally to network wide time based correlation of IP service level agreement (SLA) faults for Multi-Protocol Label Switching (MPLS) networks.

### BACKGROUND

Internet Protocol (IP) Service Level Agreement (SLA) probes may be deployed to monitor the IP connectivity of L3 VON services on a service provider's MPLS network. The IP SLA probes are configured to send fault indications from the network device on which the probe is deployed, and not from the point in the network where the connectivity is broken. IP SLA faults may be correlated to other faults reported by the network.

However, in certain cases, faults reported to a fault management system are IP SLA faults which may be due to one or more configuration issue, or a software or hardware bug in the network. When there is a single connectivity failure, there may be many traps/alarms raised in the data network due to the single failure as many IP connections may go through the same single point of failure in the network. When there is no other root cause reported by the network, there is a potential for flooding of uncorrelated IP SLA alarms as there may be no underlying condition or particular network device against which to correlate the IP SLA alarms.

### SUMMARY

### Overview

A method in particular embodiments may include receiving a first connectivity fault notification, establishing a predetermined time period when the first connectivity fault notification is receiving, receiving one or more additional connectivity fault notifications during the predetermined time period, performing a root cause analysis for the connectivity fault notification based on the received connectivity fault notification, and resolving the first and the one or more additional connectivity fault notifications based on the root cause analysis.

These and other features and advantages of the present disclosure will be understood upon consideration of the following description of the particular embodiments and the accompanying drawings.

### BRIEF DESCRIPTION OF THE DRAWINGS

FIG. 1 illustrates an example system of an overall data network;

FIG. 2 illustrates an example network device in the data network of FIG. 1;

FIG. 3 illustrates an example method for providing a time based correlation of IP SLA faults;

FIG. 4 illustrates another example method for providing a network wide time based correlation of IP SLA faults; and

FIG. 5 illustrates yet another example method for providing a network wide time based correlation of IP SLA faults.

### DETAILED DESCRIPTION

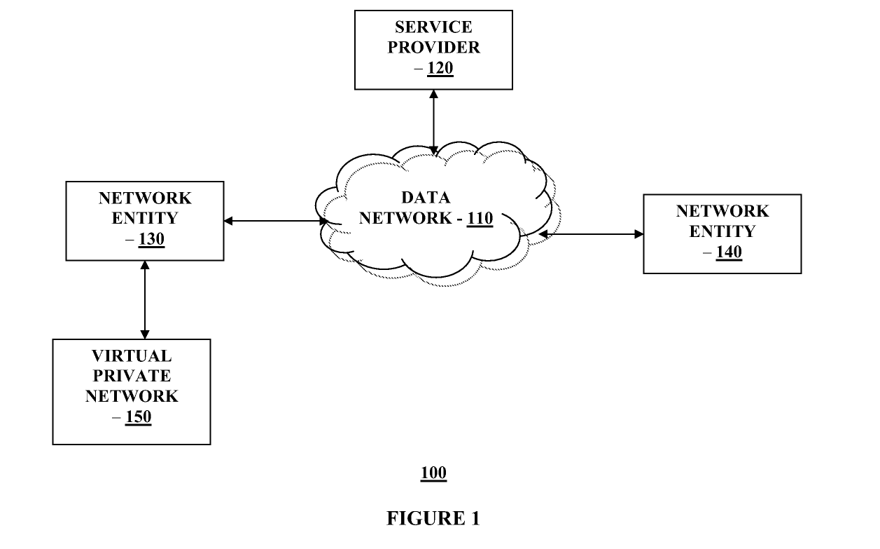

FIG. 1 illustrates an example system if an overall data network. Referring to FIG. 1, a service provider network 100 in particular embodiments includes a data network 110 which may include, for example, an IP cloud, and configured to include a MultiProtocol Label Switching (MPLS) core and further configured to carry layer 3 virtual private network (VPN) traffic. As shown in FIG. 1, there is also shown a service provider 120 operatively coupled to the data network 110, and which may be configured to include a network management software with fault detection and/or management system, and a user interface module (not shown) for providing an interface to a user to receive and/or output information from/to the user.

Referring back to FIG. 1, also shown are network entities 130, 140 which in particular embodiments may be configured as network edge routers. In addition, a virtual private network 150 is shown in FIG. 1 and operatively coupled to network entity 130. As discussed in further detail below, in particular embodiments, the service provider 120 may have probes configured to periodically transmit one or more IP packets to the network entities 130, 140 to determine connectivity status of entities operatively coupled to the respective network entities 130, 140.

As discussed in further detail below, in particular embodiments, the data network 110 including the MPLS core may include a plurality of interconnected Label Switched Paths (LSP) between the network entities 130, 140 or the provider edge routers. Moreover, in the data network 110, there may be a plurality of provider routers which are connected between the network entities 130, 140, or the edge routers. In this manner, the MPLS core may include pluralities of LSPs, and connectivity fault may occur in any path within the MPLS core.

When a connectivity fault in the MPLS core occurs, the fault may show up at the corresponding edge router (network entity, for example, in FIG. 1) to which the fault connection is linked in the MPLS core, but the source of the connectivity within the path may not be indicated at the edge router. Accordingly, in particular embodiments, when for example, an L3 VPN connection break occurs, the probes running on different provider edge routers (for example, the network entities 130, 140) may be configured to detect the connectivity problem, and report the break in connectivity for the particular LSP for which the endpoints are known, but without a specific root cause for the particular connectivity fault. In such a case, to prevent the service provider 120, for example, from being flooded with IP SLA connectivity outage alarms, a sliding time window is used to group or classify the alarms occurring within the time window into a single trouble ticket, even when the IP SLA connectivity outage alarms are reported to the service provider 120 across the data network 110 from different provider edge routers (For example, from network entities 130, 140).

In particular embodiments, the fault detection and/or management system at the service provider 120 may be configured to take the first IP SLA connectivity outage alarm as the endpoints for performing the alarm root cause analysis to determine the source of the IP SLA connectivity outage alarm to determine the point of connectivity failure. In particular embodiments, the fault detection and/or management system may be configured to perform additional diagnostic routines to determine if the other detected IP SLA connectivity outage alarms within the time window (or classified group) have the same determined root cause associated with the connectivity fault. In addition, when a fix is applied to the detected connectivity fault, it is possible to determine whether the same fix or routine may resolve the other detected IP SLA connectivity outage alarms reported to the service provider within the time window. Moreover, in particular embodiments, as alarms or notifications are cleared due to the correction of one or more identified issue associated with the triggered alarm or notification, other potential issues that exist may be identified. In the event that the predetermined fix or routine does not resolve the other detected IP SLA connectivity outage alarms reports within the time window, in particular embodiments, other fixes or routines may be applied to the respective uncleared IP SLA connectivity outage alarms, and further, the corresponding IP SLA connectivity outage alarms may be configured to remain uncleared until the appropriate fix or routine is applied and which resolves the underlying alarm condition associated with each uncleared IP SLA connectivity outage alarm. In particular embodiments, the IP SLA connectivity outage alarms may be configured to clear themselves as the probes report a restoration of connectivity.

In this manner, in particular embodiments, when multiple IP SLA connectivity outage alarms are reported that do not have a corresponding root cause for the alarm, a predetermined time window is established and each IP SLA connectivity outage alarm reported within the time window is grouped within the same trouble ticket in the fault detection and/or management system, for example, based on the probe frequency from the edge routers, as it is highly probable that the IP SLA connectivity outage alarms reported within the predetermined time window are associated with a single corresponding root cause for the connectivity fault

Accordingly, within the scope of the present disclosure, when the data network 110 has not provided a root-cause alarm, or the fault detection and/or management system has not managed to correlate against a root cause for the alarm if one is reported, the service provider 120 or the fault management system is not flooded with a large number of trouble tickets for each individual IP SLA connectivity outage alarm in the fault system for a single fault. In this manner, rather than performing root cause analysis for each IP SLA connectivity outage fault reported, in particular embodiments, when the root cause for a number of fault alarms within a time window are not known, a time-based fault correlation routine is performed using the first detected IP SLA connectivity outage alarm endpoints in the MPLS core of the data network 110 as the context in which to determine the root cause for the detected connectivity fault.

In this manner, in particular embodiments, IP SLA connectivity fault alarms may be correlated over a predetermined period of time, which is initiated at the time the first alarm is raised by the network devices or entities which have the probes configured on them to flag the connectivity faults such as, for example, the provider edge routers (network entities 130, 140) in the MPLS core of the data network 110, and not the network devices in the MPLS core that have the particular issues causing the connectivity fault alarms.

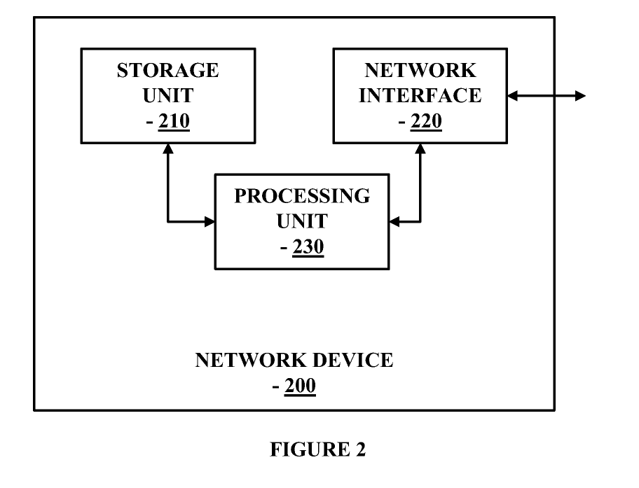

FIG. 2 illustrates an example network device in the data network of FIG. 1. Referring to FIG. 2, the network device 200 in particular embodiments includes a storage unit 210 operatively coupled to a processing unit 230. In one aspect, the processing unit 230 may include one or more microprocessors for retrieving and/or storing data from the storage unit 210, and further, for executing instructions stored in, for example, the storage unit 210, for implementing one or more associated functions. Referring again to FIG. 2, in one aspect, the network device 200 is also provided with a network interface 220 which may be configured to interface with the data network 100 (FIG. 1). In particular embodiments, the components of the network device 200 of FIG. 2 may be included in the one or more network entities 130, 140 (FIG. 1) such as, for example, provider edge routers, the service provider 120, or the virtual private network 150, as well as the provider routers within the MPLS core of the data network 100, or one or more network switches in the data network.

In particular embodiments, as discussed in further detail below, the memory or storage unit 160A of the network device 160 may be configured to store instructions which may be executed by the processing unit 160C to 1 detect a first connectivity fault notification, establish a predetermined time period when the first connectivity fault notification is detected, receive one or more additional connectivity fault notifications during the predetermined time period, perform a root cause analysis for the connectivity fault notification based on the detected connectivity fault notification, and resolve the first and the one or more additional connectivity fault notifications based on the root cause analysis.

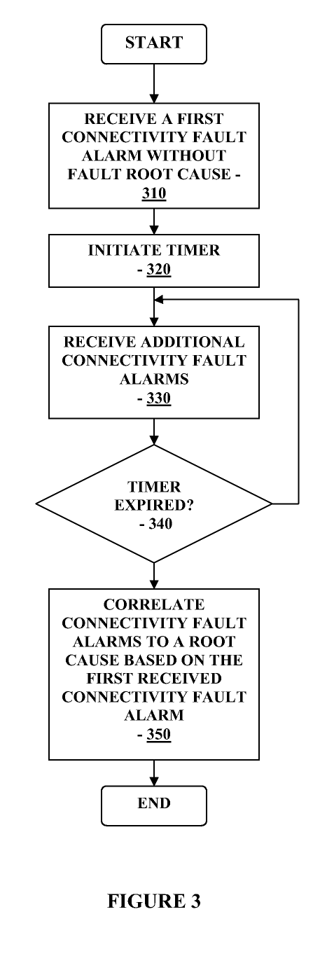

FIG. 3 illustrates an example method for providing a time based correlation of IP SLA faults in accordance with one aspect of the present disclosure. More specifically, the network wide time based correlation of IP SLA connectivity fault alarms in particular embodiments may be performed by the service provider 120 including a network management software (NMS) with a fault monitoring system. Referring to FIGS. 1 and 3, in an MPLS core of a data network such as data network 110 shown in FIG. 1, with a plurality of IP SLA probes are deployed on the edge routers such as the network entities 130, 140, each of which may be configured to periodically ping (for example, every 15 minutes, 30 minutes, or any other suitable time period based on the network design) to monitor the IP connectivity of the L3 VPN services on the MPLS network of the service provider 120 (FIG. 1).

Referring again to FIG. 3, at step 310, when one of the deployed IP SLA probes on the edge routers detect a connectivity failure in the network, a first connectivity fault alarm is raised and an associated probe trap is sent to the service provider 120 (FIG. 1), for example, to the network management software (NMS) with a fault system in the service provider 120. When the first IP SLA probe associated with a connectivity failure received by the service provider 120 is not associated with a root cause for the corresponding fault alarm condition, a timer is initiated at step 320. Thereafter, additional IP SLA connectivity fault alarms are received by the service provider 120, for example, during a predetermined time period established by the initiated timer. That is, in one aspect, at step 330, additional connectivity fault alarms are collected or received and when it is determined that at step 340 the initiated timer has not expired, the routine returns to step 330 to collect or receive additional connectivity fault alarms.

On the other hand, if at step 340 it is determined that the initiated timer has expired, the routine proceeds to step 350 where the collected or received connectivity fault alarms within the predetermined time period are correlated to a root cause for the alarm based on the first connectivity fault alarm received during the predetermined time period. That is, in one aspect of the present disclosure, when an IP SLA connectivity fault alarm that is not associated with a root cause is received or detected, a preset time period is initiated during which additional connectivity fault alarms are monitored and detected, and based upon the first IP SLA connectivity fault alarm that is not associated with a corresponding root cause for the underlying alarm condition associated with the first IP SLA connectivity fault alarm, a root cause correlation is performed. Upon determination of the correlated root cause, the received or collected connectivity fault alarms are resolved based on the correlated root cause based on a single trouble ticket.

In one aspect, if one or more connectivity fault alarms received or detected during the predetermined time period is not resolved based on the correlated root cause, then the particular one or more connectivity fault alarms may individually be analyzed for fault condition determination and resolution.

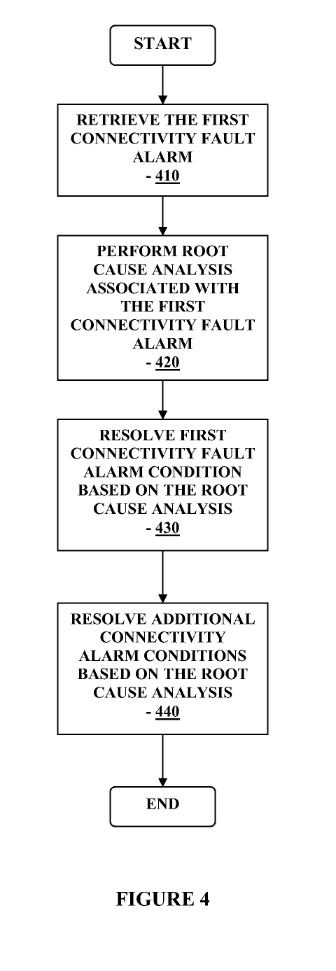

FIG. 4 illustrates another example method for providing a network wide time based correlation of IP SLA faults, and in particular, illustrates the root cause analysis of the connectivity fault alarms during the predetermined time period in further detail. Referring to FIG. 4, in one aspect, the first IP SLA connectivity fault alarm is retrieved or received at step 410 and thereafter, a root cause analysis associated with the first IP SLA connectivity fault alarms is performed at step 420. Thereafter, based on the root cause analysis performed, the first IP SLA connectivity fault alarm condition is resolved at step 430. In particular embodiments, the first IP SLA connectivity fault alarm condition may be resolved manually, for example, by a network administrator.

Referring back to FIG. 4, the remaining IP SLA connectivity fault alarms within the predefined time period is additionally resolved at step 440 based on the root cause analysis performed in conjunction with the first connectivity fault alarm. In this manner, when an IP SLA connectivity fault alarm is triggered in an MPLS core of a data network and which does not have a correlated root cause for the underlying alarm condition (for example, the basis for the connectivity outage such as the particular link within the network), a time period may be defined during which one trouble ticket may be generated and the root cause analysis performed may be applied to each of the IP SLA connectivity fault alarms that are detected during the time period.

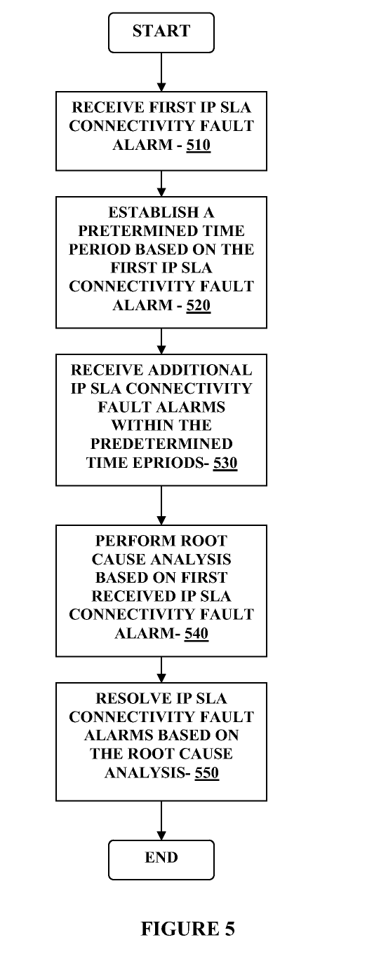

FIG. 5 illustrates yet another example method for providing a network wide time based correlation of IP SLA faults. Referring to FIG. 5, in a still another aspect of the present disclosure, at step 510, the initial IP SLA connectivity fault alarm is received or detected based upon the periodic IP probes deployed on the one or more provider edge routers or network entities 130, 140 (FIG. 1). Thereafter, a predetermined time period is established at step 520 based on the time at which the first IP SLA connectivity fault alarm is detected. Within the scope of the present disclosure, the established predetermined time period may depend upon the network configuration or design choice by the network administrator.

Referring back to FIG. 5, at step 530, additional IP SLA connectivity fault alarms detected by the IP probes for example, are received within the predetermined time period, and thereafter, upon the expiration of the predetermined time period, the fault management system of the service provider 120 (FIG. 1), for example, by the network management software (NSM) of the service provider 120 may be configured to generate a trouble ticket associated with the detected IP SLA connectivity fault alarms during the predetermined time period, and to perform a root cause analysis based on the first IP SLA connectivity fault alarm detected during the predetermined time period. Thereafter, based upon the root cause analysis performed, at step 540, the connectivity fault alarms are resolved so as to clear the alarm conditions associated with each of the IP SLA connectivity fault alarms at step 550.

As may be the case that within the predetermined time period, the plurality of IP SLA connectivity fault alarms may be associated with a single root cause, in the manner described above, in accordance with the present disclosure, the plurality of IP SLA connectivity fault alarms may be grouped in one trouble ticket in the fault detection and/or management system, for example, based on the IP probe frequency, and using the first detected IP SLA connectivity fault alarm as the basis for performing the root cause analysis, the underlying root cause for the connectivity fault alarms maybe performed to resolve the connectivity fault condition/

Accordingly, within the scope of the present disclosure, when the data network 110 has not provided a root-cause alarm, or the fault detection and/or management system has not managed to correlate against a root cause for the alarm if one is reported, the service provider 120 or the fault management system is not flooded with a large number of trouble tickets for each individual IP SLA connectivity outage alarm in the fault system for a single fault. In this manner, rather than performing root cause analysis for each IP SLA connectivity outage fault reported, in particular embodiments, when the root cause for a number of fault alarms within a time window are not known, a time-based fault correlation routine is performed using the first detected IP SLA connectivity outage alarm endpoints in the MPLS core of the data network 110 as the context in which to determine the root cause for the detected connectivity fault.

Accordingly, a method in one aspect of the present disclosure includes receiving a first connectivity fault notification, establishing a predetermined time period when the first connectivity fault notification is received, receiving one or more additional connectivity fault notifications during the predetermined time period, performing a root cause analysis for the connectivity fault notification based on the received first connectivity fault notification, and resolving the first and the one or more additional connectivity fault notifications based on the root cause analysis.

In one aspect, each of the first and the one or more additional connectivity fault notifications are not correlated with an associated connectivity root cause.

The method may also include determining absence of a correlation of the detected first connectivity fault notification to a one or more reported network connection failure.

The first and the one or more additional fault notifications may include Internet Protocol (IP) Service Level Parameter (SLA) connectivity fault alarms.

Receiving the first connectivity fault notification may include deploying a probe associated with a service level agreement parameter.

In a further aspect, the method may further include generating a trouble ticket associated with the first and the one or more additional connectivity fault notifications.

Also, the method may also include resolving a network connectivity condition associated with the first and the one or more additional connectivity fault notifications.

Additionally, the method may include clearing one or more of the first and the one or more additional connectivity fault notifications based upon the root cause analysis.

In still another aspect, performing the root cause analysis may include determining a root cause associated with the first and the one or more additional connectivity fault notifications.

An apparatus in accordance with another aspect of the present disclosure includes a network interface, one or more processors coupled to the network interface, and a memory for storing instructions which, when executed by the one or more processors, causes the one or more processors to receive a first connectivity fault notification, establish a predetermined time period when the first connectivity fault notification is received, receive one or more additional connectivity fault notifications during the predetermined time period, perform a root cause analysis for the connectivity fault notification based on the detected first connectivity fault notification; and resolve the first and the one or more additional connectivity fault notifications based on the root cause analysis.

In one aspect, each of the first and the one or more additional connectivity fault notifications are not correlated with an associated connectivity root cause.

The memory for storing instructions which, when executed by the one or more processors, may cause the one or more processors to determine an absence of a correlation of the received first connectivity fault notification to a one or more reported network connection failure.

Moreover, the first and the one or more additional fault notifications may include Internet Protocol (IP) Service Level Parameter (SLA) connectivity fault alarms.

In addition, the memory for storing instructions which, when executed by the one or more processors, may cause the one or more processors to deploy a probe associated with a service level agreement parameter.

The memory for storing instructions which, when executed by the one or more processors, may cause the one or more processors to generate a trouble ticket associated with the first and the one or more additional connectivity fault notifications.

Additionally, the memory for storing instructions which, when executed by the one or more processors, may cause the one or more processors to resolve a network connectivity condition associated with the first and the one or more additional connectivity fault notifications.

Further, the memory for storing instructions which, when executed by the one or more processors, may cause the one or more processors to clear one or more of the first and the one or more additional connectivity fault notifications based upon the root cause analysis.

Moreover, the memory for storing instructions which, when executed by the one or more processors, may cause the one or more processors to determine a root cause associated with the first and the one or more additional connectivity fault notifications.

An apparatus in accordance with still another aspect includes means for receiving a first connectivity fault notification, means for establishing a predetermined time period when the first connectivity fault notification is received, means for receiving one or more additional connectivity fault notifications during the predetermined time period, means for performing a root cause analysis for the connectivity fault notification based on the detected first connectivity fault notification, and means for resolving the first and the one or more additional connectivity fault notifications based on the root cause analysis.

The various processes described above including the processes performed by service provider 120 and/or network entities 130, 140, in the software application execution environment in the data network 100 including the processes and routines described in conjunction with FIGS. 3-5, may be embodied as computer programs developed using an object oriented language that allows the modeling of complex systems with modular objects to create abstractions that are representative of real world, physical objects and their interrelationships. The software required to carry out the inventive process, which may be stored in the memory (not shown) of the respective service provider 120 and/or network entities 130, 140 may be developed by a person of ordinary skill in the art and may include one or more computer program products.

Various other modifications and alterations in the structure and method of operation of the particular embodiments will be apparent to those skilled in the art without departing from the scope and spirit of the disclosure. Although the disclosure has been described in connection with specific particular embodiments, it should be understood that the disclosure as claimed should not be unduly limited to such particular embodiments. It is intended that the following claims define the scope of the present disclosure and that structures and methods within the scope of these claims and their equivalents be covered thereby.

What is claimed is:

1. A method, comprising:
receiving a first connectivity fault notification;
establishing a predetermined time period when the first connectivity fault notification is received;
receiving one or more additional connectivity fault notifications during the predetermined time period;
performing a root cause analysis for the connectivity fault notification based on the received first connectivity fault notification; and
resolving the first and the one or more additional connectivity fault notifications based on the root cause analysis.

2. The method of claim 1 wherein each of the first and the one or more additional connectivity fault notifications are not correlated with an associated connectivity root cause.

3. The method of claim 1 further including determining absence of a correlation of the detected first connectivity fault notification to a one or more reported network connection failure.

4. The method of claim 1 wherein the first and the one or more additional fault notifications includes Internet Protocol (IP) Service Level Parameter (SLA) connectivity fault alarms.

5. The method of claim 1 wherein receiving the first connectivity fault notification includes deploying a probe associated with a service level agreement parameter.

6. The method of claim 1 further including generating a trouble ticket associated with the first and the one or more additional connectivity fault notifications.

7. The method of claim 1 further including resolving a network connectivity condition associated with the first and the one or more additional connectivity fault notifications.

8. The method of claim 1 further including clearing one or more of the first and the one or more additional connectivity fault notifications based upon the root cause analysis.

9. The method of claim 1 wherein performing the root cause analysis includes determining a root cause associated with the first and the one or more additional connectivity fault notifications.

10. An apparatus, comprising:
a network interface;
one or more processors coupled to the network interface; and
a memory for storing instructions which, when executed by the one or more processors, causes the one or more processors to
receive a first connectivity fault notification,
establish a predetermined time period when the first connectivity fault notification is received,
receive one or more additional connectivity fault notifications during the predetermined time period,
perform a root cause analysis for the connectivity fault notification based on the detected first connectivity fault notification; and
resolve the first and the one or more additional connectivity fault notifications based on the root cause analysis.

11. The apparatus of claim 10 wherein each of the first and the one or more additional connectivity fault notifications are not correlated with an associated connectivity root cause.

12. The apparatus of claim 10 wherein the memory for storing instructions which, when executed by the one or more processors, causes the one or more processors to determine an absence of a correlation of the received first connectivity fault notification to a one or more reported network connection failure.

13. The apparatus of claim 10 wherein the first and the one or more additional fault notifications includes Internet Protocol (IP) Service Level Parameter (SLA) connectivity fault alarms.

14. The apparatus of claim 10 wherein the memory for storing instructions which, when executed by the one or more processors, causes the one or more processors to deploy a probe associated with a service level agreement parameter.

15. The apparatus of claim 10 wherein the memory for storing instructions which, when executed by the one or more processors, causes the one or more processors to generate a trouble ticket associated with the first and the one or more additional connectivity fault notifications.

16. The apparatus of claim 10 wherein the memory for storing instructions which, when executed by the one or more processors, causes the one or more processors to resolve a network connectivity condition associated with the first and the one or more additional connectivity fault notifications.

17. The apparatus of claim 10 wherein the memory for storing instructions which, when executed by the one or more processors, causes the one or more processors to clear one or more of the first and the one or more additional connectivity fault notifications based upon the root cause analysis.

18. The apparatus of claim 10 wherein the memory for storing instructions which, when executed by the one or more processors, causes the one or more processors to determine a root cause associated with the first and the one or more additional connectivity fault notifications.

19. An apparatus, comprising:
means for receiving a first connectivity fault notification;
means for establishing a predetermined time period when the first connectivity fault notification is received;
means for receiving one or more additional connectivity fault notifications during the predetermined time period;
means for performing a root cause analysis for the connectivity fault notification based on the detected first connectivity fault notification; and
means for resolving the first and the one or more additional connectivity fault notifications based on the root cause analysis.
